(19) United States
(12) Patent Application Publication
(10) Pub. No.: US 2010/0112837 A1
(43) Pub. Date: May 6, 2010

(54) FEED THROUGH WIRE TERMINAL BLOCK

(75) Inventor: Blaine Lewis, Jonesborough, TN (US)

Correspondence Address: CARTER, DELUCA, FARRELL & SCHMIDT, LLP, 445 BROAD HOLLOW ROAD, SUITE 420, MELVILLE, NY, 11747, US

(73) Assignee: TDH SOLUTIONS, L.L.C., Limestone, TN (US)

(21) Appl. No.: 12/610,550

(22) Filed: Nov. 2, 2009

Related U.S. Application Data
(60) Provisional application No. 61/110,104, filed on Oct. 31, 2008.

(51) Int. Cl. H01R 9/22

(52) U.S. Cl. 439/95; 361/818

(57) ABSTRACT

According to an embodiment of the present disclosure, a wire termination system is provided. The wire termination system has a conductive panel having a front surface and a back surface, a ground termination block attached to the front surface of the conductive panel, the ground termination block having a first terminal directly connected to the conductive panel. The system also includes a first wire termination block attached to the front surface of the conductive panel, a second wire termination block attached to the back surface of the conductive panel, and a second terminal passing through the first wire termination block and the second wire termination block.

### CROSS REFERENCE TO RELATED APPLICATIONS

The present application claims priority to U.S. Provisional Application Ser. No. 61/110,104, filed Oct. 31, 2008, entitled “FEED THROUGH WIRE TERMINAL BLOCK”, the contents of which are hereby incorporated by reference in their entirety.

### BACKGROUND

1. Technical Field

The present disclosure relates to termination blocks and, more particularly, to feed through wire termination blocks for use in railway systems, railroad wayside enclosures or the like.

2. Background

Railroad signals relays, test terminal connectors or terminal blocks have been used for many years. Typically, terminal blocks are installed in railroad wayside enclosures or field cases alongside the tracks. Terminal blocks are used to interconnect outside or “dirty” cables with equipment or “clean” wires which are used as part of railway circuits.

Such, dirty cables and clean wires are passed through an aperture in a terminal board or conductive panel when connected to a terminal block. For example, FIG. 4 depicts a conductive panel 400 that has dirty cables 404 and clean wires 402 passing through apertures 402 formed in a wall of a Faraday closet. Over time, as cables or wires are repeatedly passed through such an aperture, a protective sheath covering such cables or wires could be stripped away leaving an exposed connection that may cause a short in the railway circuit.

Accordingly, a need exists for improved terminal blocks for use in railway circuits.

### SUMMARY

The present disclosure relates to feed through wire termination blocks for use in railway systems, railroad wayside enclosures or the like.

According to an embodiment of the present disclosure, a wire termination system is provided. The wire termination system has a conductive panel having a front surface and a back surface, a ground termination block attached to the front surface of the conductive panel, the ground termination block having a first terminal directly connected to the conductive panel. The system also includes a first wire termination block attached to the front surface of the conductive panel, a second wire termination block attached to the back surface of the conductive panel, and a second terminal passing through the first wire termination block and the second wire termination block.

According to another embodiment of the present disclosure, the wire termination system has an equipment wire coupled to the second terminal.

According to another embodiment of the present disclosure, the equipment wire is a stranded wire.

According to another embodiment of the present disclosure, the wire termination system has a surge arrester coupled to the first terminal and the second terminal.

According to another embodiment of the present disclosure, the wire termination system has a hybrid surge arrester coupled to the first terminal and the second terminal.

According to another embodiment of the present disclosure, the wire termination system has a third wire termination block attached to the front surface of the conductive panel, the third wire termination block has a third terminal.

According to another embodiment of the present disclosure, the wire termination system has an outside cable coupled to the third terminal.

According to another embodiment of the present disclosure, the outside cable is a solid cable.

According to another embodiment of the present disclosure, the wire termination system has a spare conductor coupled to the first terminal.

According to another embodiment of the present disclosure, a faraday closet is provided. The faraday closet has a conductive panel having a front surface and a back surface, at least one ground termination block having at least one terminal directly connected to the conductive panel, and at least one wire termination block having at least one terminal.

According to another embodiment of the present disclosure, the second terminal extends through the conductive panel such that a first end of the second terminal extends from the front surface of the conductive panel and a second end of the second terminal extends from the back surface of the conductive panel.

According to another embodiment of the present disclosure, the faraday closet has a wire termination block having a third terminal.

According to another embodiment of the present disclosure, the faraday closet has a test strap coupled between the second terminal and the third terminal.

According to another embodiment of the present disclosure, a dielectric spacer disposed near an aperture of the test strap is provided.

According to another embodiment of the present disclosure, the faraday closet has a surge arrester coupled to the first terminal and the second terminal.

According to another embodiment of the present disclosure, the faraday closet has a hybrid surge arrester coupled to the first terminal and the second terminal.

### BRIEF DESCRIPTION OF THE DRAWINGS

The present wire termination system will be more fully appreciated as the same becomes better understood from the following detailed description when considered in connection with the following drawings, in which:

FIG. 1A is a schematic view of a feed through wire termination system, according to an embodiment of the present disclosure;

FIG. 1B is a schematic view of a feed through wire termination system, according to another embodiment of the present disclosure;

FIG. 2 is a perspective view of a dielectric spacer according to an embodiment of the present disclosure;

FIGS. 3A-3H are schematic views of the use of the feed through wire termination system, according to an embodiment of the present disclosure; and

FIG. 4 is a schematic view of a conventional faraday closet.

### DETAILED DESCRIPTION OF EMBODIMENTS

Embodiments will be described below while referencing to the accompanying figures. The accompanying figures are merely examples and are not intended to limit the scope of the invention.

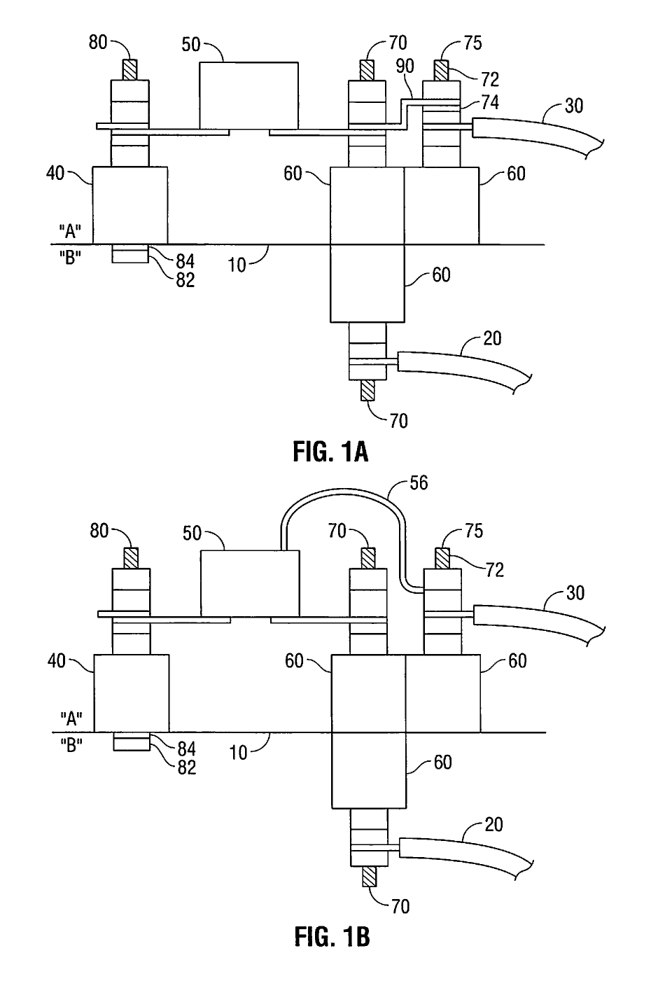

Referring to FIG. 1A, a feed through wire termination system, in accordance with an embodiment of the invention, is depicted. As shown in FIG. 1A, wire termination block 60 is attached to a conductive panel 10. Conductive panel 10 may be fabricated from any conductive material. The conductive panel 10 may be the back wall section of a faraday closet wire locker located inside a railroad wayside enclosure. Side “A” of the conductive panel 10 may be inside the faraday closet and side “B” of the conductive panel 10 may be outside of the faraday closet.

Wire termination block 60 is an injection molded piece. It may be molded as, for example, a 1″×1″ piece, a 1″×6″ piece or any other size. Each square inch has a bolt-like terminal 70 or 75 which is nickel plated brass, is about ¼ in diameter and is provided with threads 72. The terminals accept AREMA (American Railway Engineering and Maintenance-of-Way Association) specified nuts “N” and washers “W”. Each terminal 70 and 75 meets AREMA part number 14.1.10 specifications. Wire termination block 60 meets AREMA part number 14.1.5 specifications.

Ground termination block 40 is also attached to conductive panel 10. The ground termination block 40 is used with the feed through wire termination block 60 to provide a ground path for surge arresters or as a termination path for spare conductors. Terminal 80 of ground termination block 40 is directly connected to the conductive panel 10 using, for example, a bolt head 82 and star washer 84. Terminal 80 meets AREMA part number 14.1.10 specifications. Each ground termination block 40 meets AREMA part number 14.1.5 specifications.

The ground termination block is green to signify a ground connection, but it may be manufactured using any color. Preferably, the ground termination block is in a color different than wire termination block 60 so that it can be easily identified as a ground termination block.

As shown in FIG. 1A, an equipment or “clean” wire 20 is connected to terminal 70 of wire termination block 60 on side “B” of conductive panel 10. The other end of clean wire 20 may be connected to gray crossing protectors and railroad crossing protectors and/or equipment. Clean wire 20 may be a stranded 16, 14, 10 or 6 American Wire Gauge size. Clean wire 20 may be connected to terminal 70 via a crimped wire ring eye terminal.

Outside cable or “dirty” wire 30 is connected to terminal 75 of wire termination block 60 on side “A” of conductive panel 10. The other end of dirty cable 30 may be connected to signals, flashes, bells, train control signal or the like. Dirty cable 30 may be a solid conductor 14, 9 or 6 American Wire Gauge size. Dirty cable 30 may be connected to terminal 70 via a crimped wire ring eye terminal.

By placing the clean wire 20 on side “B” of the conductive panel 10 and the dirty cable 30 on side “A” of the conductive panel 10, the equipment connection can be kept as far away as possible from the outside cable connection.

A lightning or surge arrester 50 may be connected between terminal 80 of ground termination block 40 and terminal 70 of wire termination block 60. Lightning arresters, also called surge protectors, are devices that are connected between each electrical conductor in a power and communications systems and the Earth. These provide a short circuit to the ground that is interrupted by a non-conductor, over which lightning jumps. Its purpose is to limit the rise in voltage when a circuit is struck by lightning.

The non-conducting material may consist of a semi-conducting material such as silicon carbide or zinc oxide, or a spark gap. Primitive varieties of such spark gaps are simply open to the air, but more modern varieties are filled with dry gas and have a small amount of radioactive material to encourage the gas to ionize when the voltage across the gap reaches a specified level. Other designs of lightning arresters use a glow-discharge tube (essentially like a neon glow lamp) connected between the protected conductor and ground, or myriad voltage-activated solid-state switches called varistors or MOVs. Lightning arresters built for substation use are impressive devices, consisting of a porcelain tube several feet long and several inches in diameter, filled with disks of zinc oxide. A safety port on the side of the device vents the occasional internal explosion without shattering the porcelain cylinder.

A test strap 90 may also be provided between terminals 70 and 75 of the wire termination blocks. Test strap 90 may be fabricated from any suitable conductive material, non-conductive material or combination thereof (e.g., a non-conductive core coated or plated with a conductive material or vice-versa). A suitable material used to coat or plate test strap 90 may include and is not limited to nickel and/or nickel alloys. Alternatively, test strap 90 may be made entirely of nickel and/or nickel alloys.

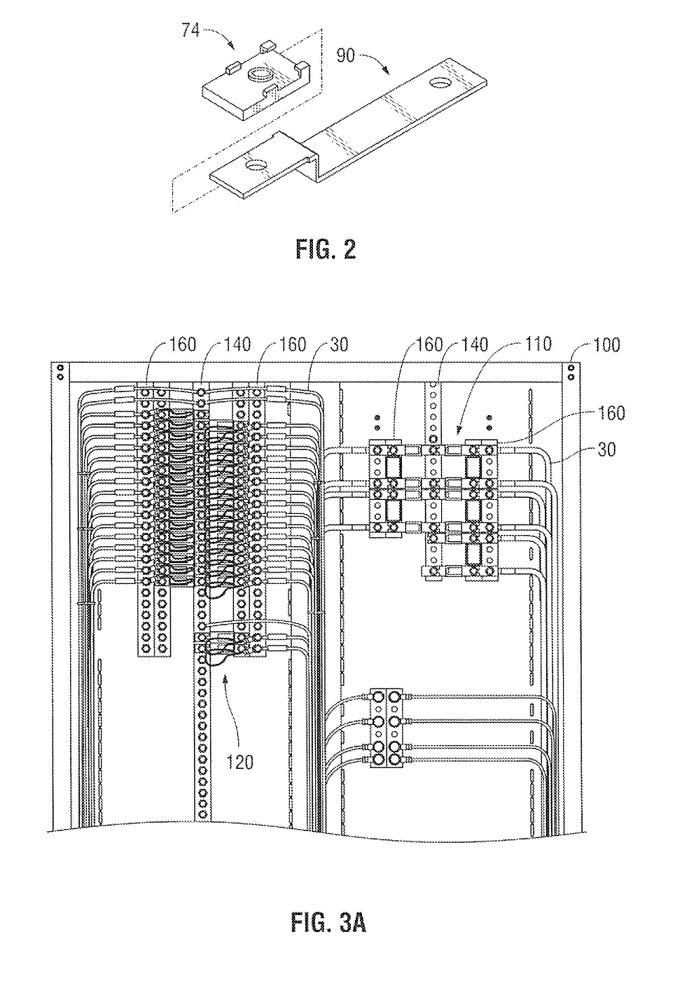

As seen in FIGS. 1A and 2, a dielectric spacer 74 may be included and positioned within an aperture of one of the ends of the test strap 90. The dielectric spacer 74 is substantially similar to the dielectric spacer in U.S. patent application Ser. No. 11/900,327, now U.S. Pat. No. 7,438,603, the contents of which are herein incorporated by reference in their entirety.

Referring to FIG. 1B, a feed through wire termination system, in accordance with another embodiment of the present disclosure, is depicted. In the system of FIG. 1B, a hybrid lightning or surge arrester 55 is connected between terminal 80 of ground termination block 40 and terminal 70 of wire termination block 60. A hybrid lightning arrester is capable of resetting itself. The hybrid lightning arrester may have an inert gas in a tube that trips a switch when a spike in energy raises the temperature beyond a threshold temperature. The hybrid arrester 55 has a wire 56 that connects to terminal 75.

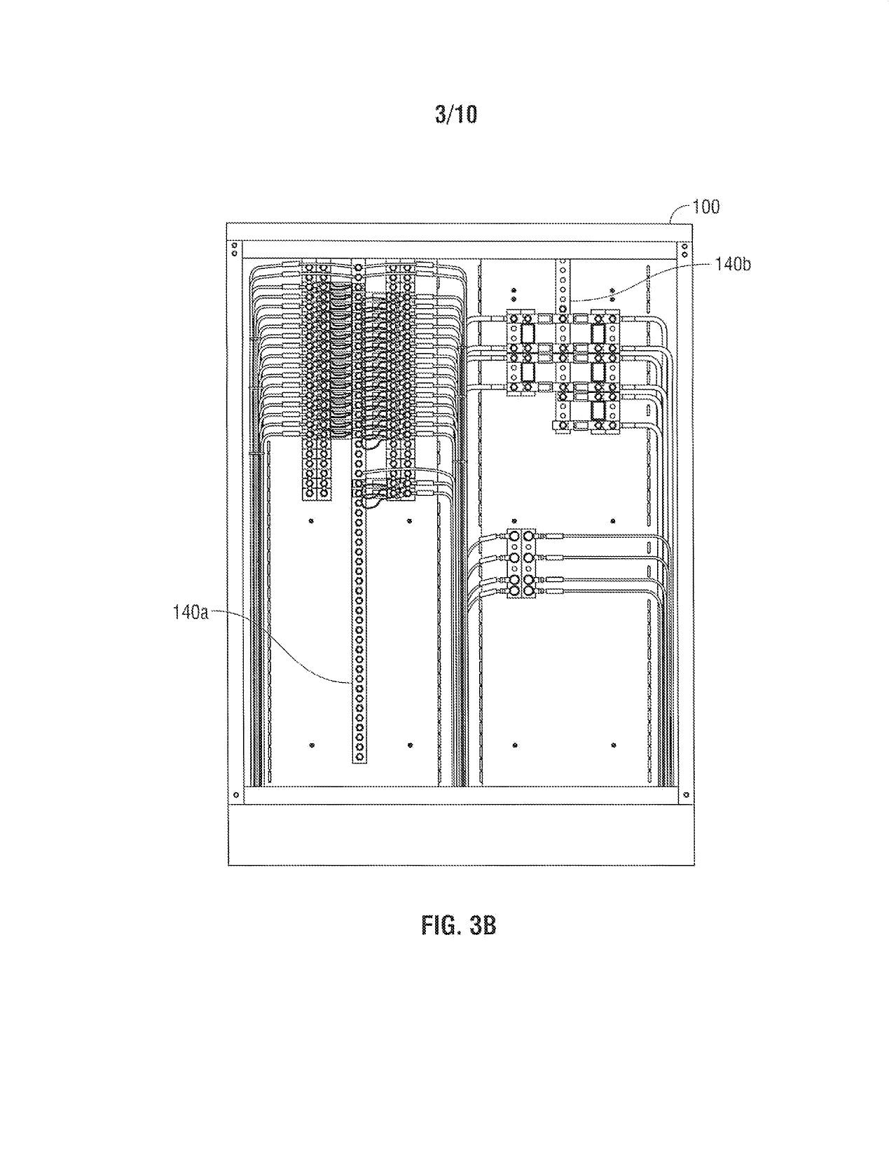

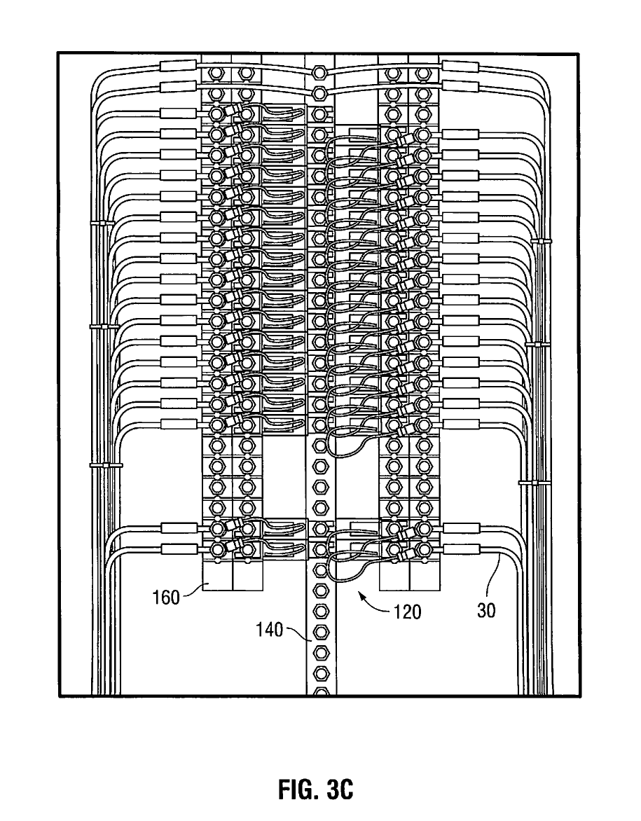

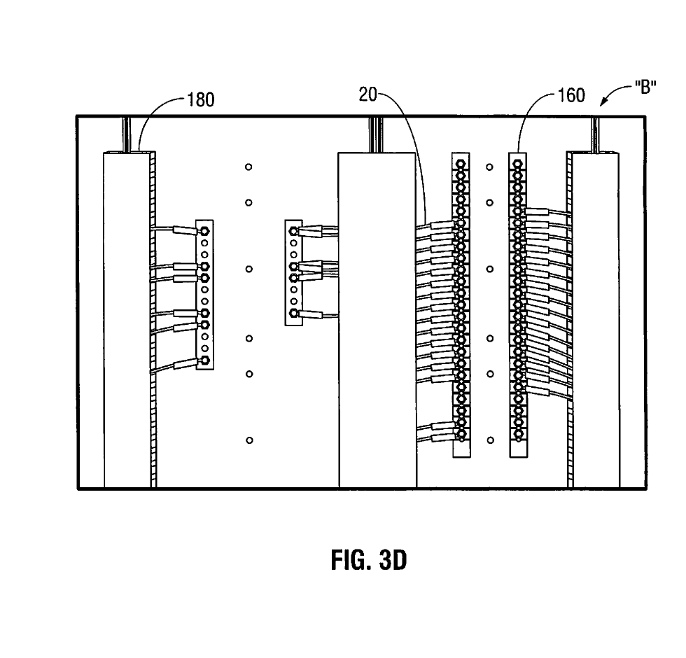

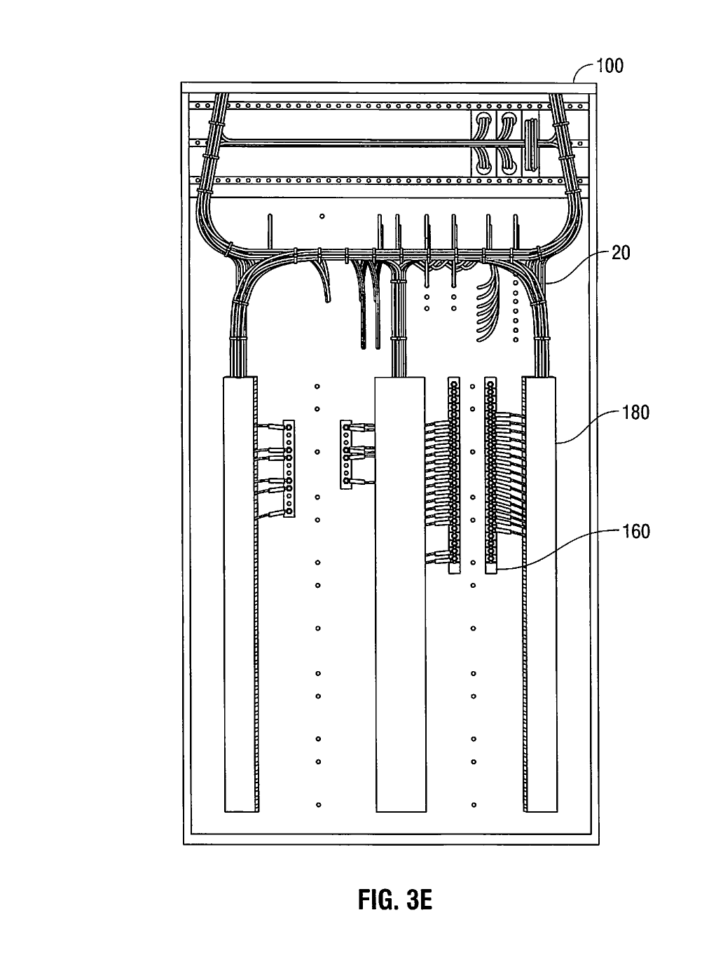

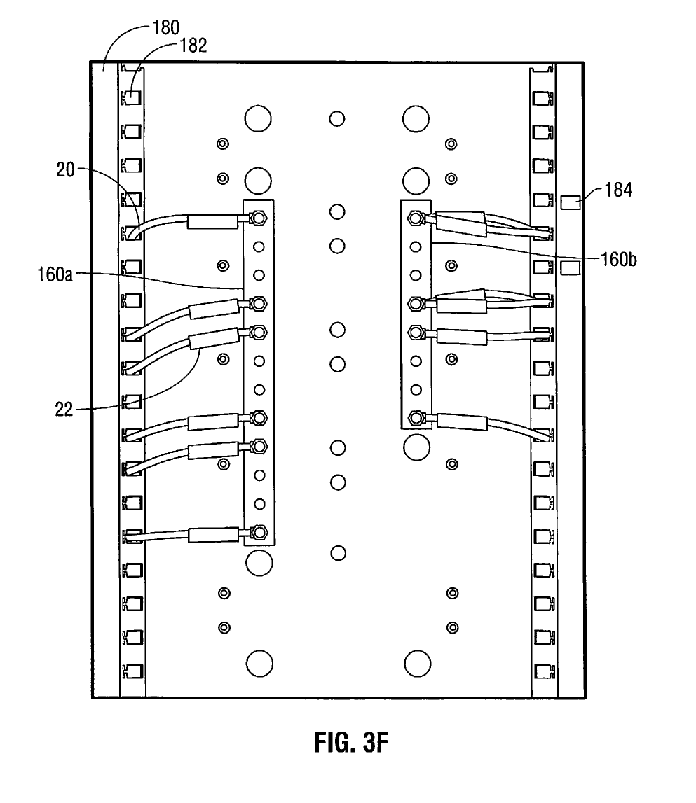

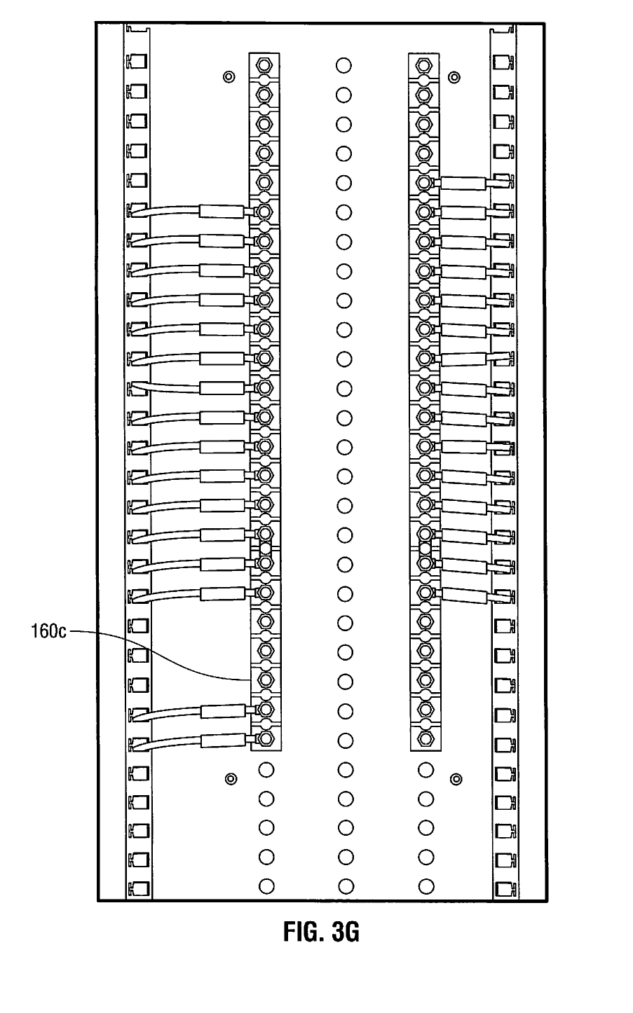

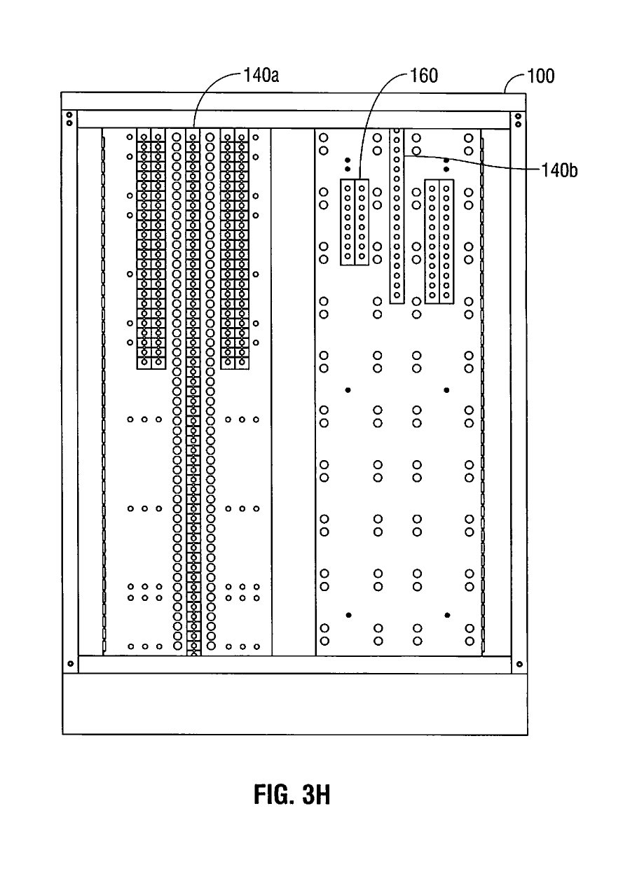

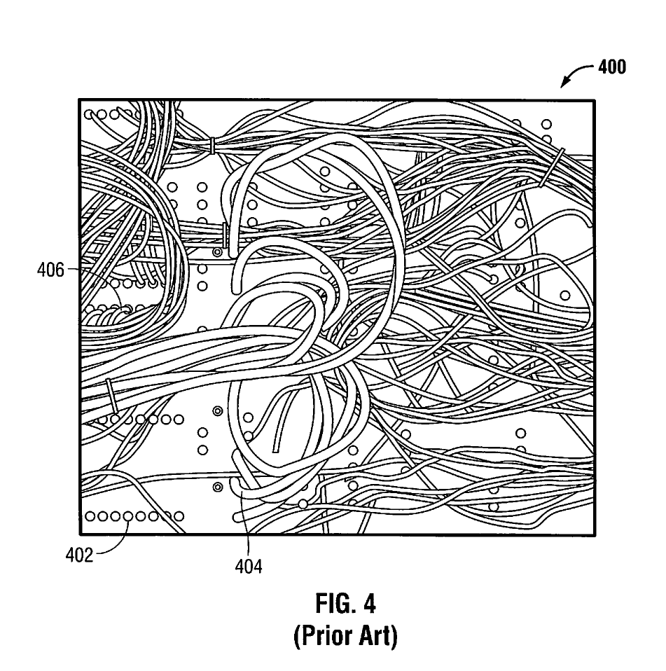

Referring to FIGS. 3A-3H, a railroad wayside enclosure or Faraday closet 100, in accordance with an embodiment of the present disclosure, is depicted. FIGS. 3A-3C and 3H depict the inside of the Faraday closet 100 or side “A” of the conductive panel while FIGS. 3D-3G depict the outside of the Faraday closet 100 or side “B” of the conductive panel.

Faraday closet 100 has a termination system 110 similar to the feed through wire termination system shown in FIG. 1A and a termination system 120 similar to the feed through wire termination system shown in FIG. 1B. Each termination system 110 and 120 are connected between a ground termination block 140 and a wire termination block 160. Outside cable or dirty wire 30 is coupled to each termination system 110 and 120. As described above, ground termination block may be formed in different sizes. For instance, as shown in FIG. 3B, ground termination block 140a is a smaller size than ground termination block 140b. Further, ground termination block 140a and 140b may be formed from a single piece (see FIG. 3B) or composed of multiple termination blocks (see FIG. 3H).

As shown in FIGS. 3D-3G, the outside of the Faraday closet 100 or side “B” of the conductive panel has multiple wire termination blocks 160. Coupled to the wire termination blocks 160 are equipment or clean wires 20. Wire termination blocks can be formed as individual wire termination blocks 160c or in different sizes as shown in FIG. 3F where wire termination block 160a is longer than wire termination block 160b.

Equipment wire or clean wire 20 can be routed from the top of the Faraday closet 100 as shown in FIG. 3E through enclosure 180. Enclosure 180 has a number of slots or openings 182 that allow the clean wire 20 to pass through. Each clean wire may have a label 22 (see FIG. 3F) to identify the piece of equipment that the clean wire is coupled with. In addition a label 184 may be applied to the enclosure 180 and may correspond to a slot to provide an indication of what is or will be coupled to the clean wire 20. For instance, label 184 may indicate which dirty wire is coupled to the wire terminal block associated with the slot 182.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods and techniques that are insubstantially different from those described above and/or in the appended claims are also intended to be within the scope of the disclosure.

1. A wire termination system comprising:
conductive panel having a front surface and a back surface;
a ground termination block attached to the front surface of said conductive panel, said ground termination block having a first terminal directly connected to said conductive panel;
a first wire termination block attached to the front surface of said conductive panel;
a second wire termination block attached to the back surface of said conductive panel; and
a second terminal passing through said first wire termination block and said second wire termination block.

2. The wire termination system according to claim 1 wherein an equipment wire is coupled to said second terminal.

3. The wire termination system according to claim 2 wherein the equipment wire is a stranded wire.

4. The wire termination system according to claim 1 wherein a surge arrester is coupled to said first terminal and said second terminal.

5. The wire termination system according to claim 1 wherein a hybrid surge arrester is coupled to said first terminal and said second terminal.

6. The wire termination system according to claim 1 further comprising a third wire termination block attached to the front surface of said conductive panel, said third wire termination block having a third terminal.

7. The wire termination system according to claim 6, wherein an outside cable is coupled to said third terminal.

8. The wire termination system according to claim 7 wherein the outside cable is a solid cable.

9. The wire termination system according to claim 1, wherein a spare conductor is coupled to said first terminal.

10. A faraday closet comprising:
a conductive panel having a front surface and a back surface;
at least one ground termination block having a first terminal directly connected to said conductive panel; and
at least one wire termination block having a second terminal.

11. The faraday closet according to claim 10, wherein said second terminal extends through said conductive panel such that a first end of said second terminal extends from said front surface of said conductive panel and a second end of said second terminal extends from said back surface of said conductive panel.

12. The faraday closet according to claim 10 further comprising a wire termination block having a third terminal.

13. The faraday closet according to claim 12 further comprising a test strap coupled between said second terminal and said third terminal.

14. The faraday closet according to claim 13 further comprising a dielectric spacer, said dielectric spacer being disposed near an aperture of said test strap.

15. The faraday closet according to claim 10 further comprising a surge arrester coupled to said first terminal and said second terminal.

16. The faraday closet according to claim 10 further comprising a hybrid surge arrester coupled to said first terminal and said second terminal.
